(19) United States
(12) Patent Application Publication
(10) Pub. No.: US 2020/0278028 A1
(43) Pub. Date: Sep. 3, 2020

(54) SEALING APPARATUS

(71) Applicant: NOK CORPORATION, Tokyo (JP)

(72) Inventors: Masahiko INOUE, Fukushima (JP); Yuya SAKANO, Fukushima (JP)

(21) Appl. No.: 16/878,779

(22) Filed: May 20, 2020

Related U.S. Application Data
(63) Continuation of application No. PCT/JP2019/040688, filed on Oct. 16, 2019.

(30) Foreign Application Priority Data
Oct. 18, 2018 (JP) 2018-197018

(51) Int. Cl. F16J 15/3264

(52) U.S. Cl. CPC F16J 15/3264

(57) ABSTRACT

A sealing apparatus is provided for sealing a gap formed between a shaft and a hole into which the shaft is to be inserted, and a first length is greater than a second length, the first length being defined between a shoulder portion, connecting the base portion and the diameter reducing portion with each other, and a bent portion, connecting the diameter reducing portion and the diameter increasing portion with each other, and the second length being defined between the bent portion and a distal end portion.

### CROSS REFERENCE TO RELATED APPLICATIONS

The present application is a continuation application of International Patent Application No. PCT/JP2019/040688 filed on Oct. 16, 2019, which claims the benefit of Japanese Patent Application No. 2018-197018, filed on Oct. 18, 2018. The contents of these applications are incorporated herein by reference in their entirety.

### BACKGROUND

### Technical Field

The present disclosure relates to a sealing apparatus to realize sealing between a shaft and a hole into which this shaft is to be inserted.

### Related Art

In a vehicle, a general-purpose machine, or the like, in order to prevent leakage of an object to be sealed, such as, for example, a lubricant, and in order to seal a gap formed between a shaft and a hole into which this shaft is to be inserted, a sealing apparatus has been conventionally used. In such a sealing apparatus, sealing between the shaft and the sealing apparatus is realized by a seal lip being brought into contact with the shaft or an annular member attached to the shaft. Contact between this seal lip and the shaft for sealing also becomes sliding resistance (torque resistance) to the shaft. In recent years, in response to a request for fuel efficiency of a vehicle, or the like, there has been a demand for a sealing apparatus to reduce sliding resistance to the shaft, and to have a structure which can realize reduction of sliding resistance to the shaft while maintaining or improving sealing performance.

While it is considered to increase the number of seal lips to improve sealing performance of the sealing apparatus, sliding resistance increases as a result of the number of seal lips being increased. To address this, a sealing apparatus (end-face lip type oil seal) is disclosed where an end-face lip which tightly contacts a flange portion of a slinger in a slidable manner is provided instead of realizing sealing by increasing the number of seal lips (see, for example, Japanese Patent No. 5964167).

The sealing apparatus is also used as a member for providing sealing to a crank shaft of an automobile engine. There may be a case where a negative pressure is generated in a crank case of the automobile engine.

In a conventional sealing apparatus, there may be a case where, when a negative pressure is generated on the side of an object to be sealed, a distal end of an end-face lip is separated from a contact with a slinger at an outer side surface of a flange portion of the slinger so that a gap is formed between the distal end of the end-face lip and the outer side surface of the slinger. In this case, in the conventional sealing apparatus, there may be a case where a liquid, which is an object to be sealed, gets over the gap, and reaches an outer peripheral surface of a cylindrical portion.

The present disclosure has been made in view of the above-described problem, and it is an object of the present disclosure to provide a sealing apparatus having improved sealing performance when a negative pressure is generated on the side of the object to be sealed.

### SUMMARY

To achieve the above-described object, the present disclosure is directed to a sealing apparatus for sealing a gap formed between a shaft and a hole into which the shaft is to be inserted, and having an annular shape, the sealing apparatus being characterized by including: a sealing apparatus body to be fitted into the hole; and a slinger to be attached to the shaft, wherein the sealing apparatus body includes a reinforcing ring and an elastic body portion, the reinforcing ring having an annular shape around an axis line, and the elastic body portion being formed of an elastic body which is attached to the reinforcing ring, and having an annular shape around the axis line, the slinger includes a flange portion which is a portion extending toward an outer periphery side, and having an annular shape around the axis line, the elastic body portion includes an end-face lip formed of a diameter reducing portion and a diameter increasing portion which is a lip having an annular shape around the axis line, the diameter reducing portion being continuously formed with a base portion which is attached to an inner peripheral end of the reinforcing ring, and having a conical tubular shape whose diameter decreases as the diameter reducing portion progresses toward one side in an axis line direction, the diameter increasing portion being continuously formed with one side of the diameter reducing portion in the axis line direction, a diameter of the diameter increasing portion increasing as the diameter increasing portion progresses toward the one side, and a distal end portion of the diameter increasing portion contacting a surface of the flange portion on another side in the axis line direction, and in the end-face lip, a length L₁ is greater than a length L₂ (L₁>L₂), the length L₁ being defined between a shoulder portion, connecting the base portion and the diameter reducing portion with each other, and a bent portion, connecting the diameter reducing portion and the diameter increasing portion with each other, and the length L₂ being defined between the bent portion and the distal end portion.

The sealing apparatus according to one aspect of the present disclosure is characterized in that, in the end-face lip, a thickness of the bent portion is smaller than a thickness of the diameter reducing portion and a thickness of the diameter increasing portion.

The sealing apparatus according to one aspect of the present disclosure is characterized in that the surface of the flange portion of the slinger on the other side has at least one groove.

In such a state, it is preferable that a no-load contact region has no groove or has the groove with a depth of 10 μm or less, the no-load contact region being a region of the flange portion which the distal end portion contacts in a state where a pressure difference between spaces separated by the end-face lip and the flange portion of the slinger is zero, and a negative pressure contact region has the groove, the negative pressure contact region being a region of the flange portion which the distal end portion contacts in a state where, of the spaces separated, a pressure of a first space on a side where the bent portion bends toward an inner side is lower than a pressure in a second space on a side where the bent portion bends toward an outer side by a predetermined pressure difference or more and, due to the pressure difference, the distal end portion moves toward a first space side on a surface of the flange portion.

It is also preferable that, in the flange portion, a positive pressure contact region has the groove, the positive pressure contact region being a region on a side opposite to the negative pressure contact region with the no-load contact region interposed between the positive pressure contact region and the negative pressure contact region.

### Effects of Disclosure

According to the present disclosure, it is possible to provide a sealing apparatus having improved sealing performance when a negative pressure is generated on the side of the object to be sealed.

### BRIEF DESCRIPTION OF THE DRAWINGS

FIG. 1 is a cross-sectional view on a cross section along an axis line for illustrating a schematic configuration of a sealing apparatus according to an embodiment of the present disclosure.

FIG. 2 is a partially enlarged cross-sectional view illustrating, in an enlarged manner, a part of the cross section along the axis line for illustrating the schematic configuration of the sealing apparatus illustrated in FIG. 1.

FIG. 3 is a view of a slinger of the sealing apparatus illustrated in FIG. 1 seen from an outer side.

FIG. 4 is a partially enlarged cross-sectional view of the sealing apparatus in a usage state where the sealing apparatus according to an embodiment of the present disclosure is attached to a housing and a shaft inserted into a shaft hole.

FIG. 5 is a partially enlarged cross-sectional view of a sealing apparatus body of the sealing apparatus in the usage state illustrated in FIG. 4, the view illustrating a state where there is no pressure difference between a side of an object to be sealed and the outer side.

FIG. 6 is a partially enlarged cross-sectional view of the sealing apparatus body in the usage state of the sealing apparatus illustrated in FIG. 5, the view illustrating a state where the side of the object to be sealed has a negative pressure with respect to the outer side.

FIG. 7 is a partially enlarged cross-sectional view of the sealing apparatus body in the usage state of the sealing apparatus illustrated in FIG. 5, the view illustrating a state where the side of the object to be sealed has a positive pressure with respect to the outer side.

### DETAILED DESCRIPTION

Hereinafter, a sealing apparatus according to an embodiment of the present disclosure will be described with reference to drawings.

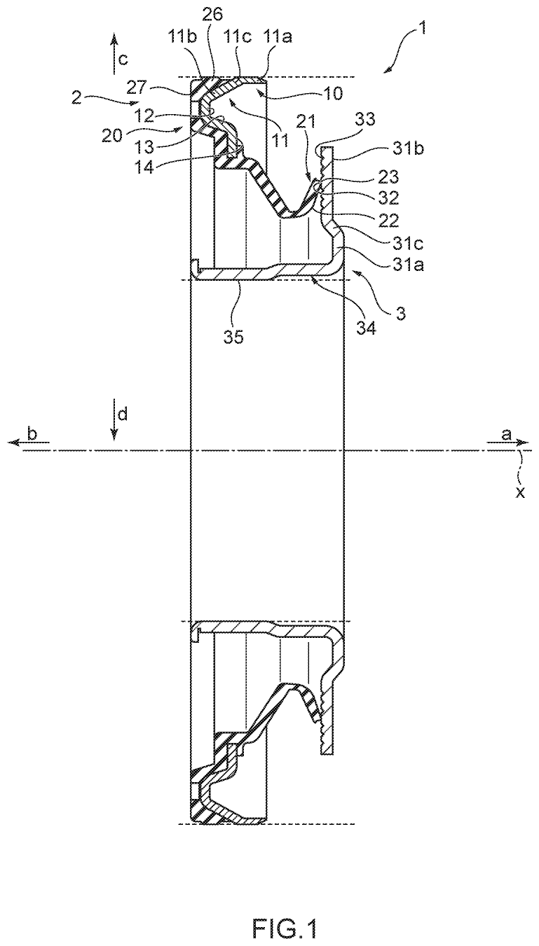

In the following description, for the purpose of illustration, a direction of an arrow a (see FIG. 1) in an axis line x direction is set as an inner side, and a direction of an arrow b (see FIG. 1) in the axis line x direction is set as an outer side. More specifically, the inner side is a side of space to be sealed (side of an object to be sealed) and a side of space where an object to be sealed such as a lubricant exists, and the outer side is an opposite side of the inner side. Further, in a direction perpendicular to the axis line x (hereinafter, also referred to as a “radial direction”), a direction away from the axis line x (a direction of an arrow c in FIG. 1) is set as an outer periphery side, and a direction approaching the axis line x (a direction of an arrow d in FIG. 1) is set as an inner periphery side.

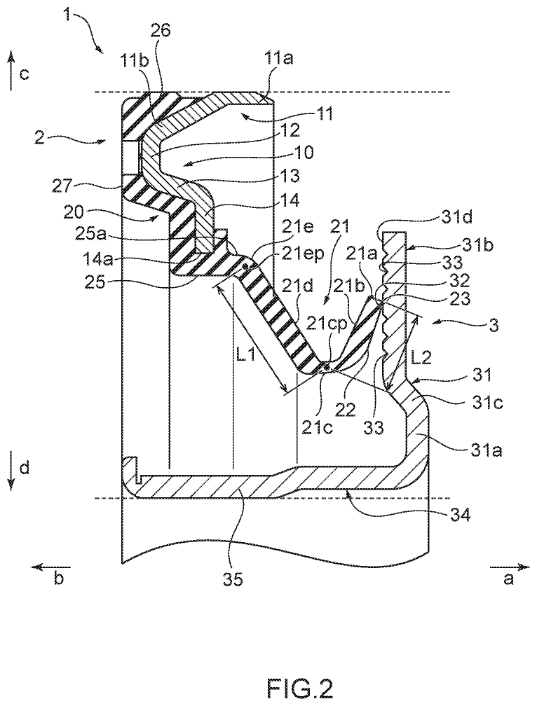

FIG. 1 is a cross-sectional view on a cross section along the axis line x for illustrating a schematic configuration of a sealing apparatus 1 according to the embodiment of the present disclosure. Further, FIG. 2 is a partially enlarged cross-sectional view illustrating, in an enlarged manner, a part of the cross section along the axis line x for illustrating the schematic configuration of the sealing apparatus 1. The configuration of the sealing apparatus 1 according to the present embodiment will be described with reference to FIG. 1 and FIG. 2. The sealing apparatus 1 according to the present embodiment is a sealing apparatus for sealing a gap having an annular shape and formed between a shaft not illustrated in the drawing and a hole (shaft hole) not illustrated in the drawing of a housing into which this shaft is to be inserted. The sealing apparatus 1 is used to seal a gap formed between this shaft and the shaft hole which is formed in the housing or the like, and into which this shaft is to be inserted in a vehicle or a general-purpose machine. For example, the sealing apparatus 1 is used to seal a space having an annular shape and formed between a crank shaft of an engine and a crank hole, which is a shaft hole formed in a front cover or a cylinder block and a crank case. Note that objects to which the sealing apparatus 1 according to the embodiment of the present disclosure may be applied are not limited to the above.

The sealing apparatus 1 according to the present embodiment includes a sealing apparatus body 2 to be fitted into a hole, and a slinger 3 to be attached to a shaft. The sealing apparatus body 2 includes a reinforcing ring 10 having an annular shape around the axis line x, and an elastic body portion 20 which is formed of an elastic body attached to the reinforcing ring 10, and which has an annular shape around the axis line x. The slinger 3 includes a flange portion 31 which is a portion extending toward the outer periphery side and having an annular shape around the axis line x. The elastic body portion 20 includes an end-face lip 21 which is a lip extending toward one side in the axis line x direction, contacting the flange portion 31 from another side in the axis line x direction, and having an annular shape around the axis line x. Hereinafter, the structure of the sealing apparatus 1 will be specifically described.

Between the housing and the shaft, the inner side of the sealing apparatus 1 is a side of an object to be sealed (a side where a first space which will be described later is formed). On the inner side, a liquid, such as an engine oil, for example, exists as the object to be sealed. The sealing apparatus 1 provides sealing in the shaft hole of the housing such that this liquid on the inner side is prevented from leaking to the outer side while insertion of the shaft through the sealing apparatus 1 is allowed.

As illustrated in FIG. 1 and FIG. 2, in the sealing apparatus body 2, the reinforcing ring 10 is a member which is made of metal and which has an annular shape centered on or substantially centered on the axis line x. The reinforcing ring 10 is formed so that the sealing apparatus body 2 is press-fitted, engaged and fitted into the shaft hole of the housing which will be described later. The reinforcing ring 10 includes, for example, a tubular portion 11 which is a portion located on the outer periphery side and having a tubular shape, a disk portion 12 which is a portion extending from an end portion on the outer side of the tubular portion 11 toward the inner periphery side, and having a hollow disk shape, a conical ring portion 13 which is an annular portion extending from an end portion on the inner periphery side of the disk portion 12 toward the inner side and the inner periphery side, and having a conical shape, and a disk portion 14 which is a portion extending in a radial direction from an end portion on the inner side or the inner periphery side of the conical ring portion 13 toward the inner periphery side, reaching an end portion (inner peripheral end 14a) on the inner periphery side of the reinforcing ring 10, and having a hollow disk shape. More specifically, the tubular portion 11 of the reinforcing ring 10 includes an outer periphery side cylindrical portion 11a which is a portion located on the outer periphery side and having a cylindrical shape or a substantially cylindrical shape, an inner periphery side cylindrical portion 11b which is a portion extending on the outer side and the inner periphery side of the outer periphery side cylindrical portion 11a and having a cylindrical shape or a substantially tubular shape, and a connecting portion 11c which is a portion connecting the outer periphery side cylindrical portion 11a and the inner periphery side cylindrical portion 11b. The outer periphery side cylindrical portion 11a of the tubular portion 11 is fitted into the shaft hole so that, when the sealing apparatus body 2 is fitted into the shaft hole of the housing which will be described later, the axis line x of the sealing apparatus body 2 matches an axis line of the shaft hole. The elastic body portion 20 is attached to the reinforcing ring 10 from a substantially outer periphery side and an outer side so as to reinforce the elastic body portion 20.

The slinger 3 includes the flange portion 31 which is a portion extending toward the outer periphery side (the direction of the arrow c) and having an annular shape around the axis line x. On another side (outer side) of the flange portion 31 of the slinger 3, at least one thread groove 33 is formed on the inner periphery side of a lip contact portion 32, which is a portion where the slinger 3 contacts the end-face lip 21.

As illustrated in FIG. 1 and FIG. 2, the elastic body portion 20 includes a base portion 25 which is a portion attached to a portion at an end on the inner periphery side of the disk portion 14 of the reinforcing ring 10, a gasket portion 26 which is a portion attached to the tubular portion 11 of the reinforcing ring 10 from the outer periphery side, and a rear cover portion 27 which is a portion attached to the reinforcing ring 10 between the base portion 25 and the gasket portion 26 from the outer side. More specifically, as illustrated in FIG. 2, the gasket portion 26 is attached to the inner periphery side cylindrical portion 11b of the tubular portion 11 of the reinforcing ring 10. Further, an outer diameter of the gasket portion 26 is greater than an outer diameter of the outer periphery side cylindrical portion 11a of the reinforcing ring 10. Therefore, when the sealing apparatus body 2 is fitted into the shaft hole which will be described later, the gasket portion 26 is compressed in the radial direction between the inner periphery side cylindrical portion 11b of the reinforcing ring 10 and the shaft hole, thus providing sealing between the shaft hole and the inner periphery side cylindrical portion 11b of the reinforcing ring 10. By this means, space between the sealing apparatus body 2 and the shaft hole is sealed. The outer diameter of the gasket portion 26 may not be greater than the outer diameter of the outer periphery side cylindrical portion 11a of the reinforcing ring 10 over the whole axis line x direction. The outer diameter of the gasket portion 26 may be partially greater than the outer diameter of the outer periphery side cylindrical portion 11a of the reinforcing ring 10. For example, a surface on the outer periphery side of the gasket portion 26 may have a protruding portion having an annular shape and having a diameter of a distal end of the protruding portion greater than the outer diameter of the outer periphery side cylindrical portion 11a of the reinforcing ring 10.

Further, the end-face lip 21 of the elastic body portion 20 extends from the base portion 25 toward the inner side (the direction of the arrow a) in an annular shape centered on or substantially centered on the axis line x. The end-face lip 21 is formed so that, in a usage state of the sealing apparatus 1 described later where the sealing apparatus 1 is attached to a desired position of an attachment object, a distal end portion 21a contacts the flange portion 31 of the slinger 3 from the outer side with a predetermined interference (a slinger contact portion 23). The base portion 25 has a projecting portion 25a which projects in an annular shape toward the inner side (the direction of the arrow a) in the axis line x direction, and the projecting portion 25a is continuously formed with the end-face lip 21.

The projecting portion 25a projects from the base portion 25 toward the inner side (the direction of the arrow a) in the axis line x direction. However, the projecting direction is not limited. For example, the projecting portion 25a may project from the base portion 25 toward the inner periphery side (the direction of the arrow d), or may project in an oblique direction between the inner side (the direction of the arrow a) and the inner periphery side (the direction of the arrow d). Further, the projecting portion 25a is not an essential component. Accordingly, it may be configured such that the projecting portion 25a has an extremely small length, or no projecting portion 25a is provided so that the projecting portion 25a cannot be distinguished from a shoulder portion 21e which will be described later.

The end-face lip 21 includes a diameter reducing portion 21d having a conical tubular shape whose diameter decreases as the diameter reducing portion 21d progresses toward the inner side (the direction of the arrow a) in the axis line x direction, and a diameter increasing portion 21b which is continuously formed with the inner side (the direction of the arrow a) of the diameter reducing portion 21d in the axis line x direction, and which has a conical tubular shape whose diameter increases as the diameter increasing portion 21b progresses toward the inner side (the direction of the arrow a). The diameter increasing portion 21b reaches the distal end portion 21a.

The projecting portion 25a and the diameter reducing portion 21d are connected with each other via the shoulder portion 21e. Further, the diameter reducing portion 21d and the diameter increasing portion 21b are connected with each other via a bent portion 21c.

That is, as illustrated in FIG. 1 and FIG. 2, the end-face lip 21 is configured as follows. In cross section along the axis line x (hereinafter, also simply referred to as “cross section”), the end-face lip 21 projects from the base portion 25 toward the inner side at the projecting portion 25a, changes the direction toward the inner side and the inner periphery side at the shoulder portion 21e, and extends obliquely with respect to the axis line x at the diameter reducing portion 21d. Thereafter, the end-face lip 21 changes the direction toward the inner side and the outer periphery side at the bent portion 21c, and extends obliquely with respect to the axis line x at the diameter increasing portion 21b, and the distal end portion 21a of the end-face lip 21 contacts the flange portion 31 of the slinger 3 from the outer side.

As illustrated in FIG. 1 and FIG. 2, in cross section, the shoulder portion 21e connects the projecting portion 25a and the diameter reducing portion 21d with a predetermined curvature (R), the projecting portion 25a and the diameter reducing portion 21d having different angles. As illustrated in FIG. 1 and FIG. 2, in cross section, the bent portion 21c is formed of a bent portion having a predetermined length and a linear shape, and portions formed on both sides of the bent portion and having curvatures. The bent portion deflects and the portions having curvatures are also bend so that the bent portion 21c connects the diameter reducing portion 21d and the diameter increasing portion 21b with each other, the diameter reducing portion 21d and the diameter increasing portion 21b having different angles.

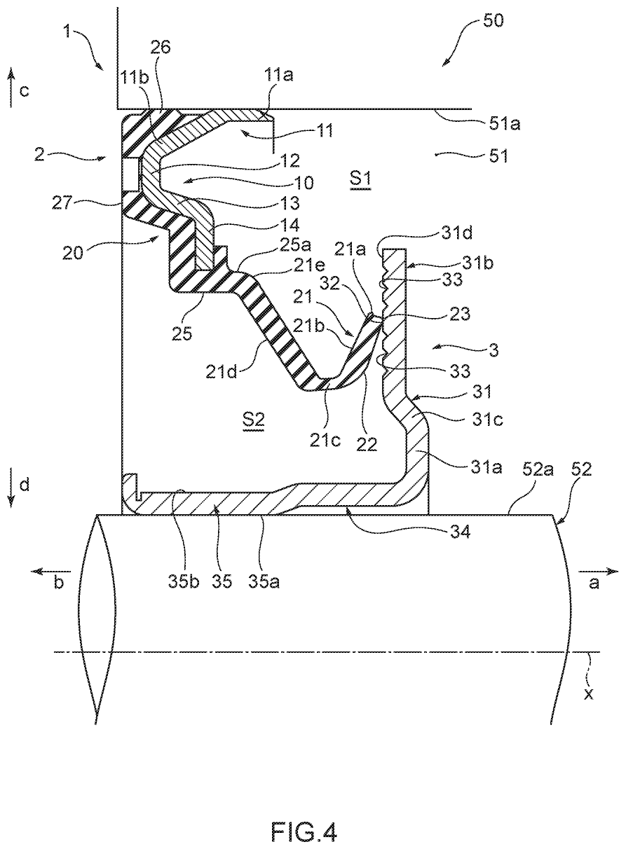

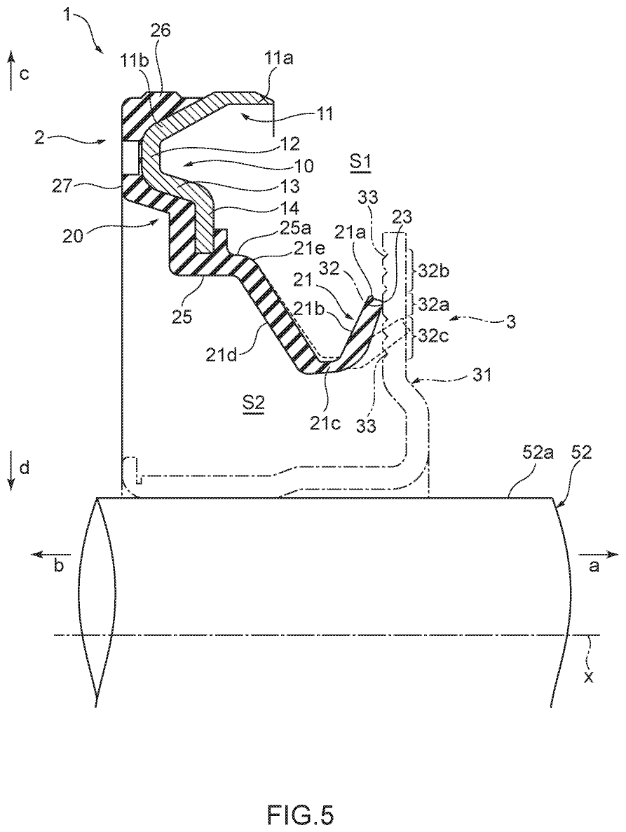

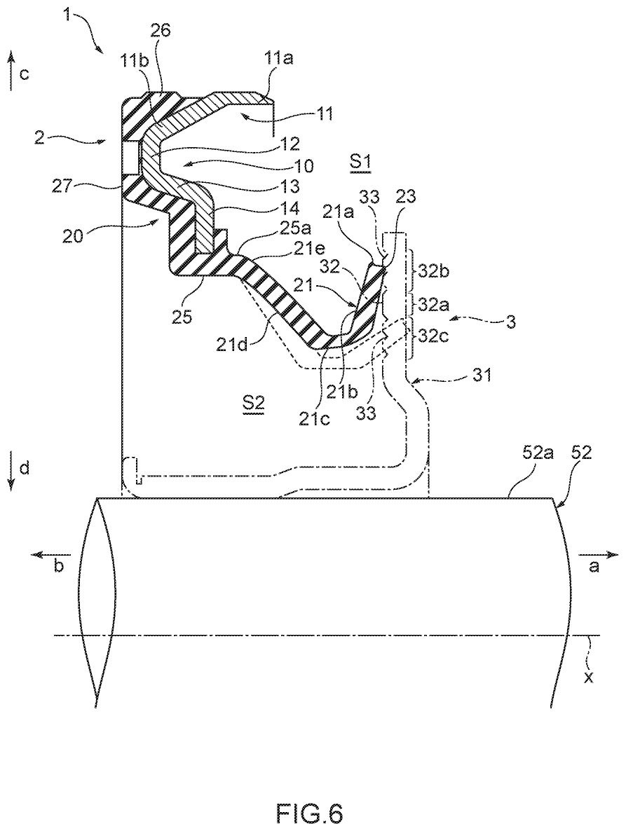

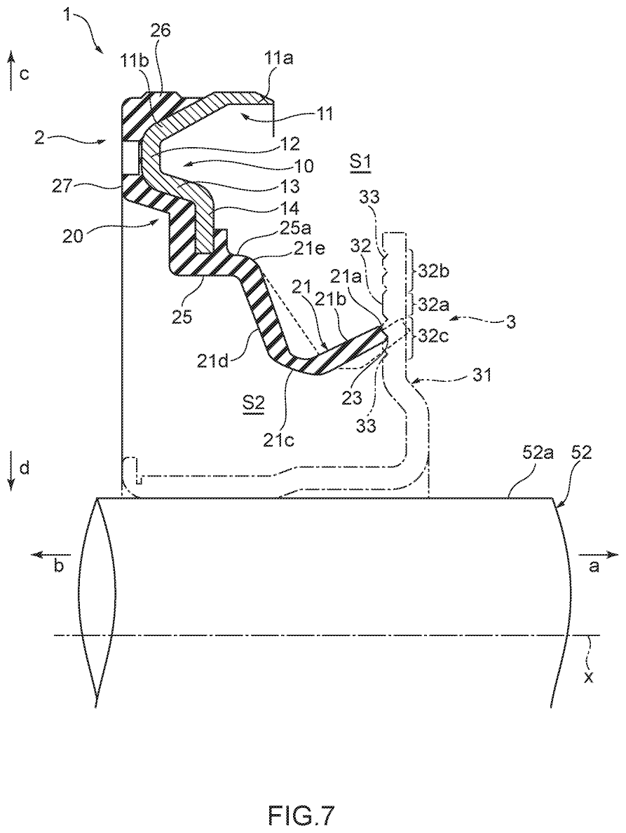

In cross section illustrated in FIG. 4, a length L₁ of the diameter reducing portion 21d is greater than a length L₂ of the diameter increasing portion 21b. In other words, the length L₁ defined between the shoulder portion 21e and the bent portion 21c is greater than the length L₂ defined between the bent portion 21c and the distal end portion 21a (L₁>L₂). In such a state, points which become references for the shoulder portion 21e and the bent portion 21c are bending points where the end-face lip 21 is folded back at the angle of the shoulder portion 21e and the bent portion 21c, and such points are also points (a shoulder portion reference point 21ep and a bent portion reference point 21cp) forming apexes of included angles which vary when the included angle of the shoulder portion 21e and the included angle of the bent portion 21c are varied by causing the distal end portion 21a to slide toward the inner periphery side and the outer periphery side against an outer side surface 31d of the flange portion 31 (indicating that the distal end portion 21a is moved to have a state illustrated in FIG. 7 from a state illustrated in FIG. 6 which will be described later via a state illustrated in FIG. 5 and, further, the distal end portion 21a is moved in the opposite direction). Although the portion to be bent has a large length, the apex of the included angle of the portion to be bent is fixed at one point, and the bent portion reference point 21cp is disposed at substantially the center of the portion to be bent.

As illustrated in FIG. 2, the end-face lip 21 is configured such that a thickness of the bent portion 21c is smaller than a thickness of the diameter reducing portion 21d and a thickness of the diameter increasing portion 21b. In a free state before the sealing apparatus 1 is assembled, the included angle at the bent portion reference point 21cp of the bent portion 21c is larger. Accordingly, when the slinger 3 is attached to the sealing apparatus body 2 with a predetermined interference, the included angle at the bent portion reference point 21cp is reduced. Therefore, a reaction force resulting from the reduction in the included angle causes the distal end portion 21a to contact the outer side surface 31d of the flange portion 31 such that the distal end portion 21a pushes against the outer side surface 31d of the flange portion 31. Setting the thickness of the bent portion 21c smaller than the thicknesses of other portions can reduce a reaction force at the bent portion 21c so that it is possible to suppress an increase in torque when the sealing apparatus is used.

The above-described reinforcing ring 10 is formed of a metal material, and examples of this metal material can include, for example, stainless steel and SPCC (cold rolled steel sheet). Further, examples of the elastic body of the elastic body portion 20 can include, for example, various kinds of rubber materials. The various kinds of rubber materials can include, for example, synthetic rubber such as nitrile rubber (NBR), hydrogenated nitrile rubber (H-NBR), acryl rubber (ACM), and fluorine-containing rubber (FKM).

The reinforcing ring 10 is manufactured through, for example, press work or forging, and the elastic body portion 20 is molded through cross-linking (vulcanization) molding using a mold. Upon this cross-linking molding, the reinforcing ring 10 is disposed in the mold, and the elastic body portion 20 is caused to adhere to the reinforcing ring 10 through cross-linking adhesion so that the elastic body portion 20 and the reinforcing ring 10 are integrally molded.

The slinger 3 is a member having an annular shape and to be attached to the shaft when the sealing apparatus 1 is in the usage state which will be described later. The slinger 3 is a member having an annular shape centered on or substantially centered on the axis line x. The slinger 3 has a cross section having a substantially L shape, and includes the flange portion 31, and a tubular portion 34 which is connected to an end portion on the inner periphery side of the flange portion 31, which extends in the axis line x direction, and which has a tubular shape or a substantially tubular shape.

The flange portion 31 specifically includes an inner periphery side disk portion 31a in a hollow disk shape or a substantially hollow disk shape which extends from the tubular portion 34 in the radial direction, an outer periphery side disk portion 31b in a hollow disk shape or a substantially hollow disk shape which expands on the outer periphery side of the inner periphery side disk portion 31a and which extends in the radial direction, and a connecting portion 31c which connects an end portion on the outer periphery side of the inner periphery side disk portion 31a and an end portion on the inner periphery side of the outer periphery side disk portion 31b. The outer periphery side disk portion 31b is located on the outer side of the inner periphery side disk portion 31a in the axis line x direction. Note that the shape of the flange portion 31 is not limited to the above-described shape, and may be any of various shapes in accordance with an application object. For example, the flange portion 31 may not include the inner periphery side disk portion 31a and the connecting portion 31c, and the outer periphery side disk portion 31b may extend to the tubular portion 34, and may be connected to the tubular portion 34, thus forming a portion in a hollow disk shape or a substantially hollow disk shape which extends from the tubular portion 34 in the radial direction.

The lip contact portion 32 of the flange portion 31 where the end-face lip 21 contacts is formed on the outer side surface 31d of the outer periphery side disk portion 31b which is a surface facing the outer side. It is preferable that the outer side surface 31d is a surface extending along a plane expanding in the radial direction.

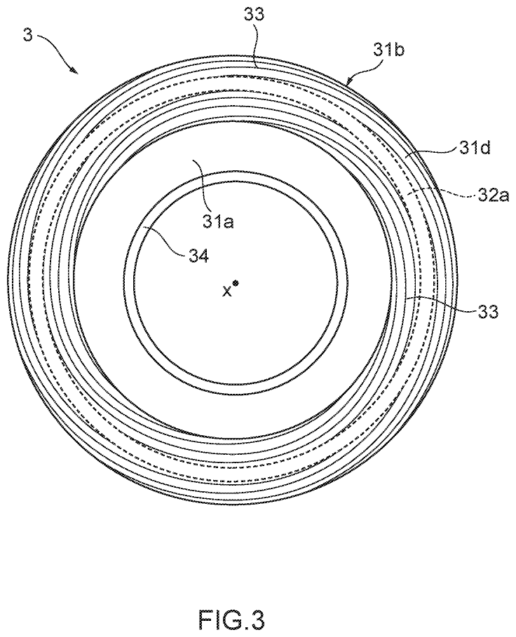

FIG. 3 is a view of the slinger 3 of the sealing apparatus 1 seen from the outer side. As illustrated in FIG. 3, the thread groove 33 formed of a recessed portion which is recessed toward the inner side is formed on the outer side surface 31d of the flange portion 31. The thread groove 33 ranges from the inner periphery side to the outer periphery side. To be more specific, the thread groove 33 has a spiral shape and, as will be described later, a region 32a where no thread groove 33 is formed is present at an intermediate portion of the range from the inner periphery side to the outer periphery side. With the provision of this thread groove 33, an air flow which flows toward the outer periphery side can be formed when the slinger 3 is rotated, thus causing a pumping action. On the outer side surface 31d of the flange portion 31, the thread groove 33 is located on the inner periphery side of the lip contact portion 32. For example, the thread groove 33 having multiple threads is formed on the outer side surface 31d of the flange portion 31. The number of thread grooves 33 and a shape along which the thread groove 33 extends are not limited to the above. For example, the thread groove 33 has a shape along a line drawn on a plane orthogonal to an axis line of a conical surface when a thread groove formed on this conical surface and having a spiral shape is projected on this plane.

Further, in the present embodiment, as illustrated in FIG. 3, on the outer side surface 31d of the flange portion 31, no thread groove 33 is present in the region 32a (“no-load contact region 32a” which will be described later) which is separated from the axis line x by a predetermined distance and which has an annular shape. As will be described later, this region 32a where no thread groove 33 is present is a region of the flange portion 31 which the distal end portion 21a of the end-face lip 21 contacts when there is no pressure difference between spaces separated by the diameter increasing portion 21b of the end-face lip 21 and the flange portion 31 of the slinger 3. The thread groove 33 is formed in a region (“a negative pressure contact region 32h” which will be described later) on the outer periphery side of the region 32a and in a region (“positive pressure contact region 32c” which will be described later=a region on the side opposite to the negative pressure contact region 32b with the no-load contact region 32a interposed therebetween) on the inner periphery side of the region 32a. The negative pressure contact region 32b and the positive pressure contact region 32c are divided by the no-load contact region 32a.

The depth of this thread groove 33 may be appropriately selected, and is selected from a range from approximately 40 to 100 μm, for example.

As illustrated in FIG. 2, the tubular portion 34 of the slinger 3 includes a cylindrical portion 35, which is a portion at least partially having a cylindrical shape or a substantially cylindrical shape. This cylindrical portion 35 is formed so as to be able to be fitted on the shaft. That is, an inner diameter of the cylindrical portion 35 is smaller than a diameter of the outer peripheral surface of the shaft so that the cylindrical portion 35 can be interference-fitted at the shaft. The slinger 3 is not limited to a part fixed by the cylindrical portion 35 being interference-fitted at the shaft, and may be fixed at the shaft through adhesion by the tubular portion 34, or may be fixed at the shaft using other publicly known fixing method. Note that the whole tubular portion 34 may be formed of the cylindrical portion 35.

The slinger 3 is made using a metal material and, for example, made using stainless steel excellent in rust resistance and rust-proofness. When the slinger 3 is made using stainless steel, it is possible to suppress occurrence of rust at the lip contact portion 32, which is a sliding portion against the end-face lip 21, so that it is possible to maintain a sealing function and sealing performance of the end-face lip 21 for a long period of time. It is also possible to suppress that occurrence of rust changes the shape of the thread groove 33. Therefore, it is possible to suppress the reduction in pumping effect which is exerted by the thread groove 33. The material for forming the slinger 3 is not limited to stainless steel, and the slinger 3 may be made using other metals. Note that it is preferable that rust-proofing, such as rust-proofing plating, is performed on the surface of the slinger 3, particularly on the lip contact portion 32.

Action of the sealing apparatus 1 having the above-described configuration will be described next.

FIG. 4 is a partially enlarged cross-sectional view of the sealing apparatus 1 in a usage state where the sealing apparatus 1 is attached to a housing 50, which is an attachment object, and to a shaft 52 inserted into a shaft hole 51, which is a through hole formed in the housing 50. The housing 50 may be, for example, a front cover of an engine, or a cylinder block and a crank case, and the shaft hole 51 may be a crank hole formed in the front cover, or the cylinder block and the crank case. Further, the shaft 52 may be, for example, a crank shaft.

As illustrated in FIG. 4, when the sealing apparatus 1 is in the usage state, the sealing apparatus body 2 is fitted into the shaft hole 51 by being press-fitted into the shaft hole 51, and the slinger 3 is attached to the shaft 52 by being interference-fitted at the shaft 52. More specifically, the outer periphery side cylindrical portion 11a of the reinforcing ring 10 contacts an inner peripheral surface 51a of the shaft hole 51, so that an axis of the sealing apparatus body 2 is made to match an axis of the shaft hole 51. Further, the gasket portion 26 of the elastic body portion 20 tightly contacts the inner peripheral surface 51a of the shaft hole 51 by the gasket portion 26 being compressed in the radial direction between the inner peripheral surface 51a of the shaft hole 51 and the inner periphery side cylindrical portion 11b of the reinforcing ring 10, so that sealing between the sealing apparatus body 2 and the shaft hole 51 is realized. Further, the cylindrical portion 35 of the slinger 3 is press-fitted on the shaft 52, and an inner peripheral surface 35a of the cylindrical portion 35 tightly contacts an outer peripheral surface 52a of the shaft 52, so that the slinger 3 is fixed at the shaft 52.

When the sealing apparatus 1 is in the usage state, relative positions between the sealing apparatus body 2 and the slinger 3 in the axis line x direction are determined so that the slinger contact portion 23 of the end-face lip 21 of the elastic body portion 20 contacts the lip contact portion 32, the slinger contact portion 23 being a portion on a distal end portion 21a side of an inner peripheral surface 22, and the lip contact portion 32 being a portion on the outer side surface 31d of the outer periphery side disk portion 31b of the flange portion 31 of the slinger 3.

FIG. 5 illustrates a partially enlarged cross-sectional view of the sealing apparatus body 2 of the sealing apparatus 1 in the usage state illustrated in FIG. 4. In FIG. 5, the slinger 3 is indicated by a chain line. Further, in FIG. 5, the shape of the end-face lip 21 in the free state before the sealing apparatus 1 is assembled is indicated by a dotted line.

In the state illustrated in FIG. 5, of the spaces separated by the end-face lip 21 and the flange portion 31 of the slinger 3, a pressure in a first space S1 on a side where the bent portion 21c is bent toward the inner side (the side of the object to be sealed, inner side) is equal to a pressure in a second space S2 on a side where the bent portion 21c is bent toward the outer side (outer side) (there is no pressure difference), and both sides are at atmospheric pressure. In this state, the distal end portion 21a of the end-face lip 21 contacts the outer side surface 31d of the flange portion 31 in the no-load contact region 32a.

For example, when an engine is operated so that the shaft 52 starts to be rotated, the inside of the crank case of the engine is held at a negative pressure for environmental protection. Accordingly, a pressure on the side of the object to be sealed, that is, the pressure in the first space S1, is reduced, thus having a negative pressure state and hence, the pressure in the first space S1 becomes lower than the pressure in the second space S2. Therefore, the end-face lip 21 is attracted toward the first space S1 side due to a pressure difference. When a pressure difference between both spaces becomes a predetermined value or more, as illustrated in FIG. 6, the distal end portion 21a of the end-face lip 21 contacts the outer side surface 31d of the flange portion 31 while moving to the negative pressure contact region 32b. FIG. 6 is a partially enlarged cross-sectional view of the sealing apparatus body 2 in the usage state of the sealing apparatus 1 illustrated in FIG. 5, and FIG. 6 illustrates a state where the pressure in the first space S1 (side of the object to be sealed) is lower than the pressure in the second space S2 (outer side) (a state where a negative pressure is generated in the first space S1).

When the end-face lip 21 is attracted toward the first space S1 side by the negative pressure, the entire end-face lip 21 is attracted. The end-face lip 21 is observed for respective portions. In the diameter increasing portion 21b, a pressure difference (negative pressure) acts, using the bent portion 21c as a base point, in a direction toward the outer side (the direction of the arrow b), that is, in a direction along which the distal end portion 21a is separated from the outer side surface 31d of the flange portion 31. In the diameter reducing portion 21d, a pressure difference (negative pressure) acts, using the shoulder portion 21e as a base point, in a direction toward the inner side (the direction of the arrow a), that is, in a direction along which the distal end portion 21a is pushed against the outer side surface 31d of the flange portion 31.

As has been described above, the length L₁ of the diameter reducing portion 21d is greater than the length L₂ of the diameter increasing portion 21b (L₁>L₂). Accordingly, the action toward the inner side (the direction of the arrow a) at the diameter reducing portion 21d is dominant to the action toward the outer side (the direction of the arrow b) at the diameter increasing portion 21b. As a result, in the state illustrated in FIG. 6, the distal end portion 21a is pushed against the outer side surface 31d of the flange portion 31 by an action of a negative pressure. Therefore, in the sealing apparatus 1 of the present embodiment, an object to be sealed is prevented from easily leaking even in a negative pressure state and hence, it is possible to improve sealing performance when a negative pressure is generated on the side of the object to be sealed. Further, the diameter increasing portion 21b contacts the outer side surface 31d of the flange portion 31 at the distal end portion 21a in the same direction as a normal end-face lip and hence, there is no possibility that a function as the end-face lip is impaired.

Provided that the size relationship between the length L₁ of the diameter reducing portion 21d and the length L₂ of the diameter increasing portion 21b satisfies L₁>L₂, the above-described action and advantageous effect can be expected. However, an extremely small difference between L₁ and L₂ weakens, during a negative pressure state, an action of pushing the distal end portion 21a against the outer side surface 31d of the flange portion 31, the action being caused by the diameter reducing portion 21d. On the other hand, an extremely small length L₂ with respect to the length L₁ weakens a lip effect, which is the original effect of the end-face lip 21. Accordingly, it is desirable that L₂ is appropriately smaller than L₁.

On the outer side surface 31d of the flange portion 31 of the slinger 3, the thread groove 33, which forms multiple threads, is formed in the negative pressure contact region 32b where the distal end portion 21a of the end-face lip 21 is located in the state illustrated in FIG. 6. When the slinger 3 is rotated, the thread groove 33 forms an air flow which flows toward the outer periphery side. Due to this air flow which is generated by the rotation of the thread groove 33 (the slinger 3), a pumping action is generated in a region in the vicinity of the slinger contact portion 23 and the lip contact portion 32. Due to this pumping action, even when an object to be sealed leaks from the first space S1 side (the side of the object to be sealed) to the second space S2 side (outer side), the leaked object to be sealed is caused to get over the slinger contact portion 23 and the lip contact portion 32 to return to the first space S1 side (the side of the object to be sealed). As described above, due to a pumping action generated by the thread groove 33 formed on the flange portion 31 of the slinger 3, it is possible to suppress leakage of the object to be sealed to the second space S2 side (outer side).

Whereas, during a static state where a driving device, such as an engine, is not operated, pressure reduction on the side of the object to be sealed, that is, pressure reduction in the first space S1, is released so that the first space S1 is brought into an atmospheric pressure state, thus bringing about a state where there is no pressure difference between the first space S1 and the second space S2, that is, the state illustrated in FIG. 5. In the state illustrated in FIG. 5, the distal end portion 21a of the end-face lip 21 contacts the outer side surface 31d of the flange portion 31 in the no-load contact region 32a. The no-load contact region 32a has no thread groove 33. Therefore, according to the sealing apparatus of the present embodiment, it is possible to solve the problem of leakage in a static state.

In the present embodiment, the no-load contact region 32a has no thread groove 33. However, the no-load contact region 32a may have a groove with an extremely shallow depth, for example, a groove having a depth of 10 μm or less. The groove with an extremely shallow depth of up to approximately 10 μm does not easily cause leakage in a static state. Further, in the case where the groove with an extremely shallow depth is provided to the no-load contact region 32a as described above, even when an operation is performed in a state where there is no pressure difference between the first space S1 and the second space S2, a pumping action caused by the groove can be expected. Accordingly, it is possible to suppress leakage of the object to be sealed to the second space S2 side (outer side).

In the case where the groove with an extremely shallow depth up to approximately 10 μm is provided to the no-load contact region 32a, it is preferable that the number of threads of the groove is set to a large number. The appropriate number of threads in an actual operation differs depending on the depth of the groove. Accordingly, it is sufficient to select the appropriate number of threads by observing a situation of leakage in a static state and leakage of the object to be sealed during operation.

Depending on the operation state of the engine, there may be a case where a positive pressure is suddenly generated in the crank case of the engine. In such a case, a pressure is applied to the side of the object to be sealed, that is, the first space S1, so that the pressure in the first space S1 becomes higher than the pressure in the second space S2. In such a case, the end-face lip 21 is pushed toward the second space S2 side due to the pressure difference. Further, when a pressure difference between both spaces becomes a predetermined value or more, as illustrated in FIG. 7, the distal end portion 21a of the end-face lip 21 contacts the outer side surface 31d of the flange portion 31 while moving to the positive pressure contact region 32c. FIG. 7 is a partially enlarged cross-sectional view of the sealing apparatus body 2 in the usage state of the sealing apparatus 1 illustrated in FIG. 5, and FIG. 7, and illustrates a state where the pressure in the first space S1 (the side of the object to be sealed) is higher than the pressure in the second space S2 (outer side) (a state where a positive pressure is generated in the first space S1).

When the end-face lip 21 is pushed toward the second space S1 side by a positive pressure, the entire end-face lip 21 is pushed. The end-face lip 21 is observed for respective portions. In the diameter increasing portion 21b, a pressure difference (positive pressure) acts, using the bent portion 21c as a base point, in a direction toward the inner side (the direction of the arrow a), that is, in a direction along which the distal end portion 21a is pushed against the outer side surface 31d of the flange portion 31. On the other hand, in the diameter reducing portion 21d, a pressure difference (negative pressure) acts, using the shoulder portion 21e as a base point, in a direction along which the bent portion 21c is moved toward outer side (the direction of the arrow b). As can be understood from FIG. 7, this movement of the diameter reducing portion 21d acts not in a direction along which the distal end portion 21a is separated from the outer side surface 31d of the flange portion 31, but in a direction along which the distal end portion 21a is pushed against the outer side surface 31d of the flange portion 31. As a result, in the state illustrated in FIG. 7, the distal end portion 21a is pushed against the outer side surface 31d of the flange portion 31 due to the action of a positive pressure. Therefore, in the sealing apparatus 1 of the present embodiment, the object to be sealed is prevented from easily leaking even in a positive pressure state, and there is no possibility that sealing performance is impaired when a positive pressure is generated on the side of the object to be sealed.

On the outer side surface 31d of the flange portion 31 of the slinger 3, the thread groove 33, which forms multiple threads, is formed in the positive pressure contact region 32c where the distal end portion 21a of the end-face lip 21 is located in the state illustrated in FIG. 7. Therefore, in the same manner as the state illustrated in FIG. 6 where the distal end portion 21a is located in the negative pressure contact region 32b, in the sealing apparatus 1 of the present embodiment, also in a positive pressure state, due to a pumping action generated by the thread groove 33 formed on the flange portion 31 of the slinger 3, it is possible to suppress leakage of the object to be sealed to the second space S2 side (outer side).

The embodiment of the present disclosure has been described heretofore. However, the present disclosure is not limited to the sealing apparatus 1 according to the above-described embodiment of the present disclosure, and includes any mode which falls within the concept and Claims of the present disclosure. Further, the respective components may be selectively combined as desired to solve or provide at least part of the above-described problems or effects. For example, the shape, the material, the arrangement, the size and the like of the respective components in the above-described embodiment may be suitably changed depending on a specific use mode of the present disclosure.

As described above, the shape of the thread groove 33 of the slinger 3 is not limited to a thread shape illustrated in FIG. 3, and may be any of other shapes.

In the present embodiment, the elastic body portion 20 does not include other lips, such as a dust lip and an intermediate lip. However, these lips may be provided to space on the inner periphery side of the base portion 25, for example.

In general, the dust lip is a lip which extends from the base portion 25 toward the axis line x. The dust lip is a member where the distal end portion of the dust lip is formed to contact the cylindrical portion 35 of the slinger 3 from the outer periphery side and, in a usage state, the dust lip prevents intrusion of foreign substances, such as dust and moisture, into the sealing apparatus 1 from the outer side, which is the side opposite to the side of the object to be sealed.

In general, the intermediate lip is a lip which extends from the base portion 25 toward the inner side. The intermediate lip extends from the base portion 25 in an annular shape centered on or substantially centered on the axis line x, and forms a recessed portion between the intermediate lip and the base portion 25, the recessed portion having an annular shape, and being open toward the inner side. In the usage state, there may be a case where the object to be sealed gets over the slinger contact portion 23, which contacts the slinger 3 of the end-face lip 21, and leaks in the inside. The intermediate lip is formed to cause this leaked object to be sealed to be stored in the recessed portion formed between the intermediate lip and the base portion 25 in such a case.

To cope with leakage of an object to be sealed in a negative pressure state, it is desirable to provide other lips, such as the dust lip and the intermediate lip. However, according to the present embodiment, it is possible to omit or simplify these other lips. When these other lips are omitted or simplified so that it becomes unnecessary to cause these other lips to slide against the slinger 3, not only that the apparatus can be simplified, but also that short lifespan of the lip caused by sliding, and an increase in torque can be avoided.

Further, while description is provided that the sealing apparatus 1 according to the present embodiment is applied to a crank hole of an engine, an application object of the sealing apparatus according to the present disclosure is not limited to this, and the present disclosure can be applied to all configurations which can utilize the effects provided by the present disclosure, such as other vehicles, general-purpose machine and industrial machine.

What is claimed is:

1. A sealing apparatus for sealing a gap formed between a shaft and a hole into which the shaft is to be inserted, and having an annular shape, the sealing apparatus comprising:
a sealing apparatus body to be fitted into the hole; and
a slinger to be attached to the shaft,
wherein the sealing apparatus body includes a reinforcing ring and an elastic body portion, the reinforcing ring having an annular shape around an axis line, and the elastic body portion being formed of an elastic body which is attached to the reinforcing ring, and having an annular shape around the axis line,
the slinger includes a flange portion which is a portion extending toward an outer periphery side, and having an annular shape around the axis line,
the elastic body portion includes an end-face lip formed of a diameter reducing portion and a diameter increasing portion which is a lip having an annular shape around the axis line, the diameter reducing portion being continuously formed with a base portion which is attached to an inner peripheral end of the reinforcing ring, and having a conical tubular shape whose diameter decreases as the diameter reducing portion progresses toward one side in an axis line direction, the diameter increasing portion being continuously formed with one side of the diameter reducing portion in the axis line direction, a diameter of the diameter increasing portion increasing as the diameter increasing portion progresses toward the one side, and a distal end portion of the diameter increasing portion contacting a surface of the flange portion on another side in the axis line direction, and
in the end-face lip, a length L₁ is greater than a length L₂ (L₁>L₂), the length L₁ being defined between a shoulder portion, connecting the base portion and the diameter reducing portion with each other, and a bent portion, connecting the diameter reducing portion and the diameter increasing portion with each other, and the length L₂ being defined between the bent portion and the distal end portion.

2. The sealing apparatus according to claim 1, wherein
in the end-face lip, a thickness of the bent portion is smaller than a thickness of the diameter reducing portion and a thickness of the diameter increasing portion.

3. The sealing apparatus according to claim 1, wherein
the surface of the flange portion of the slinger on the other side has at least one groove.

4. The sealing apparatus according to claim 3, wherein
a no-load contact region has no groove or has the groove with a depth of 10 μm or less, the no-load contact region being a region of the flange portion which the distal end portion contacts in a state where a pressure difference between spaces separated by the end-face lip and the flange portion of the slinger is zero, and
a negative pressure contact region has the groove, the negative pressure contact region being a region of the flange portion which the distal end portion contacts in a state where, of the spaces separated, a pressure of a first space on a side where the bent portion bends toward an inner side is lower than a pressure in a second space on a side where the bent portion bends toward an outer side by a predetermined pressure difference or more and, due to the pressure difference, the distal end portion moves toward a first space side on a surface of the flange portion.

5. The sealing apparatus according to claim 4, wherein
in the flange portion, a positive pressure contact region has the groove, the positive pressure contact region being a region on a side opposite to the negative pressure contact region with the no-load contact region interposed between the positive pressure contact region and the negative pressure contact region.
